(19) United States
(12) Patent Application Publication
(10) Pub. No.: US 2023/0125025 A1
(43) Pub. Date: Apr. 20, 2023

(54) LITHIUM SECONDARY BATTERY

(71) Applicant: Samsung SDI Co., Ltd., Yongin-si, Gyeonggi-do (KR)

(72) Inventors: Hyejin PARK, Yongin-si (KR); Sujeong KOH, Yongin-si (KR); Dahyun KIM, Yongin-si (KR); Myunghoon KIM, Yongin-si (KR); Sanghyung KIM, Yongin-si (KR); Sanghoon KIM, Yongin-si (KR); Seungryong OH, Yongin-si (KR)

(21) Appl. No.: 17/905,059

(22) PCT Filed: Feb. 17, 2021
(86) PCT No.: PCT/KR2021/002017

§ 371 Date: Aug. 25, 2022

(30) Foreign Application Priority Data
Mar. 26, 2020 (KR) 10-2020-0037017

(51) Int. Cl. H01M 10/0567; H01M 4/62; H01M 10/0525; H01M 4/525; H01M 4/38; H01M 4/587; H01M 4/36; H01M 4/131; H01M 4/133; H01M 4/134

(52) U.S. Cl. CPC H01M 10/0567; H01M 4/625; H01M 10/0525; H01M 4/525; H01M 4/386; H01M 4/587; H01M 4/364; H01M 4/366; H01M 4/131; H01M 4/133; H01M 4/134; H01M 2300/0025

(57) ABSTRACT

Provided is a lithium secondary battery including a positive electrode including a positive electrode current collector, and a positive active material layer on the positive electrode current collector; a negative electrode including a negative active material; and an electrolyte solution including a non-aqueous organic solvent, a lithium salt, and an additive, the positive active material layer includes a positive active material and carbon nanotube, an average length of the carbon nanotube is greater than or equal to 1 μm and less than 200 μm, the carbon nanotube is included in an amount of greater than or equal to 0.5 wt % and less than 4 wt % based on the total weight of the positive active material layer, and the additive includes a phosphate-based compound represented by Chemical Formula 1.

### TECHNICAL FIELD

This disclosure relates to a lithium secondary battery.

### BACKGROUND ART

A lithium secondary battery may be recharged and has three or more times as high energy density per unit weight as a conventional lead storage battery, nickel-cadmium battery, nickel hydrogen battery, nickel zinc battery and the like. It may be also charged at a high rate and thus, is commercially manufactured for a laptop, a cell phone, an electric tool, an electric bike, and the like, and researches on improvement of additional energy density have been actively made.

In particular, as IT devices increasingly achieve high performance, a high-capacity battery is required, but the high capacity may be realized through expansion of a voltage range, increasing energy density but bringing about a problem of deteriorating performance of a positive electrode due to oxidization of an electrolyte solution in the high voltage range.

For example, LiPF₆, which is most often used as a lithium salt of the electrolyte solution, reacts with an electrolyte solvent to promote depletion of the solvent and generate a large amount of gas. LiPF₆ is decomposed and produces a decomposition product such as HF, PF₅, and the like, which causes the electrolyte depletion and leads to performance deterioration and insufficient safety at a high temperature.

The decomposition products of the electrolyte solution are deposited into a film on the surface of an electrode to increase internal resistance of the battery and eventually cause problems of deteriorating battery performance and shortening a cycle-life. In particular, this side reaction is further accelerated at a high temperature where a reaction rate becomes faster, and gas components generated due to the side reaction may rapidly increase an internal pressure of the battery and thus have a fatal adverse effect on stability of the battery.

An oxidization of the electrolyte solution in the high voltage range is very accelerated and thus known to greatly increase resistance of the electrode during the long-term charge and discharge process.

Accordingly, an electrolyte solution applicable under conditions of a high voltage and a high-temperature condition is being required.

### DISCLOSURE

### Technical Problem

An embodiment provides a lithium secondary battery having improved initial resistance and high-temperature storage characteristics by preventing sudden heat generation during overcharging to improve overcharge stability and at the same time improving impregnation properties of a positive electrode in the electrolyte solution.

### Technical Solution

An embodiment of the present invention provides a lithium secondary battery including a positive electrode including a positive electrode current collector, and a positive active material layer on the positive electrode current collector; a negative electrode including a negative active material; and an electrolyte solution including a non-aqueous organic solvent, a lithium salt, and an additive,

wherein the positive active material layer includes a positive active material and carbon nanotube, an average length of the carbon nanotube is greater than or equal to 1 μm and less than 200 μm, the carbon nanotube is included in an amount of greater than or equal to 0.5 wt % and less than 4 wt % based on the total weight of the positive active material layer, and

the additive includes a phosphate-based compound represented by Chemical Formula 1.

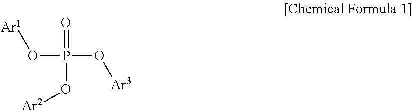

In Chemical Formula 1,

Ar¹ to Ar³ are each independently a substituted or unsubstituted C6 to C20 aryl group.

An average length of the carbon nanotube may be 50 μm to 150 μm.

The carbon nanotube may be included in an amount of 0.5 wt % to 3 wt % based on the total weight of the positive active material layer.

The phosphate-based compound represented by Chemical Formula 1 may be included in an amount of greater than or equal to 0.1 wt % and less than 3 wt % based on the total weight of the electrolyte solution.

The phosphate-based compound represented by Chemical Formula 1 may be triphenyl phosphate (TPP).

The positive active material may be at least one type of lithium composite oxide represented by Chemical Formula 3.

LiₐM¹_{1-y1-z1}M²_{y1}M³_{z1}O₂ [Chemical Formula 3]

In Chemical Formula 3, 0.9≤a≤1.8, 0≤y1≤1, 0≤z1≤1, 0≤y1+z1<1, and M¹, M², and M³ are each independently any one selected from metals such as Ni, Co, Mn, Al, Sr, Mg, or La, and a combination thereof.

The positive active material may be a lithium composite oxide represented by Chemical Formula 3-1.

Liₓ₂Ni_{y2}CO_{z2}Al_{1-y2-z2}O₂ [Chemical Formula 3-1]

In Chemical Formula 3-1, 1≤x2≤1.2, 0.5≤y2≤1, and 0≤z2≤0.5.

The negative active material may include a Si—C composite including a Si-based active material and a carbon-based active material.

The negative active material may further include crystalline carbon.

The crystalline carbon may include graphite, and the graphite may include natural graphite, artificial graphite, or a mixture thereof.

The Si—C composite may further include a shell surrounding the surface of the Si—C composite, and the shell may include amorphous carbon.

The amorphous carbon may include soft carbon, hard carbon, a mesophase pitch carbonized product, calcined coke, or a mixture thereof.

### Advantageous Effects

A lithium secondary battery having improved initial resistance and high-temperature storage characteristics may be realized.

### DESCRIPTION OF THE DRAWINGS

FIG. 1 is a schematic view illustrating a lithium secondary battery according to an embodiment of the present invention.

FIG. 2 is a graph showing resistance characteristics of a lithium secondary battery cells according to the content of carbon nanotube.

FIG. 3 is a graph showing resistance characteristics of the lithium secondary battery cells according to the length of the carbon nanotube.

FIG. 4 is a graph showing resistance characteristics of the lithium secondary battery cells according to the content of the additive.

### DESCRIPTION OF SYMBOLS

100: lithium secondary battery
112: negative electrode
113: separator
114: positive electrode
120: battery case
140: sealing member

### MODE FOR INVENTION

Hereinafter, a lithium secondary battery according to an embodiment of the present invention will be described in detail with reference to the accompanying drawings. However, these embodiments are exemplary, the present invention is not limited thereto and the present invention is defined by the scope of claims.

A lithium secondary battery may be classified into a lithium ion battery, a lithium ion polymer battery, and a lithium polymer battery depending on types of a separator and an electrolyte and also may be classified to be cylindrical, prismatic, coin-type, pouch-type, and the like depending on shapes. In addition, it may be bulk type and thin film type depending on sizes. Structures and manufacturing methods for these batteries pertaining to this disclosure are well known in the art.

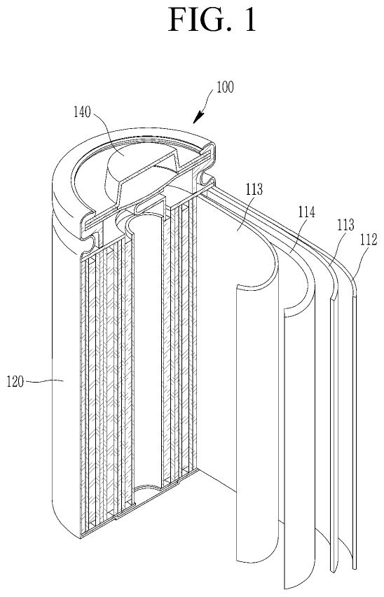

Herein, a cylindrical lithium secondary battery will be exemplarily described as an example of the lithium secondary battery. FIG. 1 schematically shows the structure of a lithium secondary battery according to an embodiment. Referring to FIG. 1, a lithium secondary battery 100 according to an embodiment includes a battery cell including a positive electrode 114, a negative electrode 112 facing the positive electrode 114, a separator 113 between the positive electrode 114 and the negative electrode 112, and an electrolyte solution (not shown) impregnating the positive electrode 114, the negative electrode 112, and the separator 113, a battery case 120 housing the battery cell, and a sealing member 140 sealing the battery case 120.

Hereinafter, a more detailed configuration of the lithium secondary battery 100 according to an embodiment of the present invention will be described.

A lithium secondary battery according to an embodiment of the present invention includes a positive electrode, a negative electrode, and an electrolyte solution.

The electrolyte solution includes a non-aqueous organic solvent, a lithium salt, and an additive, and the additive includes a phosphate-based compound represented by Chemical Formula 1.

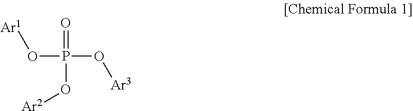

In Chemical Formula 1,

Ar¹ to Ar³ are each independently a substituted or unsubstituted C6 to C20 aryl group.

The phosphate-based compound represented by Chemical Formula 1 is decomposed in an electrolyte solution to form polyphosphoric acid, which is a non-volatile polymer, and the polyphosphoric acid undergoes esterification and dehydrogenation to form a carbon layer, and the carbon layer thus may exhibit a flame-retardant effect by blocking oxygen and latent heat.

That is, by using the additive including the phosphate-based compound represented by Chemical Formula 1, overcharge safety and high-temperature storage characteristics of the battery may be improved.

The phosphate-based compound represented by Chemical Formula 1 may be included in an amount of greater than or equal to 0.1 wt % and less than 3 wt % based on the total weight of the electrolyte solution.

For example, the phosphate-based compound represented by Chemical Formula 1 may be included in an amount of 0.1 wt % to 2 wt % based on the total weight of the electrolyte solution.

When the amount of the phosphate-based compound represented by Chemical Formula 1 is within the above range, a lithium secondary battery may exhibit improved overcharge safety and high-temperature storage characteristics without deterioration in cycle-life.

For example, the phosphate-based compound represented by Chemical Formula 1 may be triphenyl phosphate (TPP).

The triphenyl phosphate is a representative flame-retardant material having a flash point of about 223° C., and is a material having excellent thermal blocking effect due to the formation of polyphosphoric acid.

Meanwhile, the additive may further include other additives in addition to the aforementioned additive.

The other additives may include at least one of vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), succinonitrile (SN), polysulfone, 1,3,6-hexane tricyanide (HTCN), propene sultone (PST), propane sultone (PS), lithium tetrafluoroborate (LiBF₄), lithium difluorophosphate (LiPO₂F₂), and 2-fluoro biphenyl (2-FBP).

By further including the aforementioned other additives, cycle-life may be further improved or gases generated from the positive electrode and the negative electrode may be effectively controlled during high-temperature storage.

The other additives may be included in an amount of 0.2 wt % to 20 wt %, specifically 0.2 wt % to 15 wt %, or for example 0.2 wt % to 10 wt %, based on the total weight of the electrolyte solution for a lithium secondary battery.

When the content of other additives is as described above, the increase in film resistance may be minimized, thereby contributing to the improvement of battery performance.

The non-aqueous organic solvent serves as a medium for transmitting ions taking part in the electrochemical reaction of a battery.

The non-aqueous organic solvent may be a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include methyl acetate, ethyl acetate, n-propyl acetate, t-butyl acetate, methylpropionate, ethyl propionate, propyl propionate, decanolide, mevalonolactone, caprolactone, and the like. The ether-based solvent may include dibutyl ether, tetraglyme, diglyme, dimethoxyethane, 2-methyltetrahydrofuran, tetrahydrofuran, and the like. In addition, the ketone-based solvent may include cyclohexanone, and the like. The alcohol-based solvent may include ethanol, isopropyl alcohol, and the like and the aprotic solvent may include nitriles such as R—CN (wherein R is a hydrocarbon group having a C2 to C20 linear, branched, or cyclic structure and may include a double bond, an aromatic ring, or an ether bond), and the like, amides such as dimethyl formamide, and the like, dioxolanes such as 1,3-dioxolane, and the like, sulfolanes, and the like.

The non-aqueous organic solvent may be used at alone or in a mixture, and when the organic solvent is used in a mixture, the mixture ratio may be controlled in accordance with a desirable battery performance.

The carbonate-based solvent is prepared by mixing a cyclic carbonate and a linear carbonate. When the cyclic carbonate and linear carbonate are mixed together in a volume ratio of 5:5 to 1:9, an electrolyte performance may be improved.

In particular, in an embodiment, the non-aqueous organic solvent may include the cyclic carbonate and the linear carbonate in a volume ratio of 5:5 to 2:8, and as a specific example, the cyclic carbonate and the linear carbonate may be included in a volume ratio of 4:6 to 2:8.

As a more specific example, the cyclic carbonate and the linear carbonate may be included in a volume ratio of 3:7 to 2:8.

The non-aqueous organic solvent may further include an aromatic hydrocarbon-based organic solvent in addition to the carbonate-based solvent.

Herein, the carbonate-based solvent and the aromatic hydrocarbon-based organic solvent may be mixed in a volume ratio of 1:1 to 30:1.

The aromatic hydrocarbon-based organic solvent may be an aromatic hydrocarbon-based compound of Chemical Formula 2.

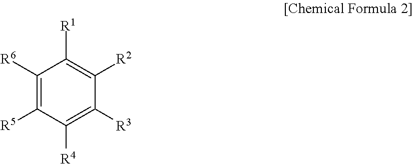

In Chemical Formula 2, R⁷ to R¹² are the same or different and are selected from hydrogen, a halogen, a C1 to C10 alkyl group, a haloalkyl group, and a combination thereof.

Specific examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The lithium salt dissolved in the non-organic solvent supplies lithium ions in a battery, enables a basic operation of a lithium secondary battery, and improves transportation of the lithium ions between positive and negative electrodes. Examples of the lithium salt include at least one supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide, LiFSI), LiC₄F₉SO₃, LiClO₄, LiAlO₂, LiAlCl₄, LiN(CₓF₂ₓ₊₁SO₂)(CyF_{2y+1}SO₂) (wherein, x and y are natural numbers, for example, an integer ranging from 1 to 20), LiCl, Lil, and LiB(C₂O₄)₂ (lithium bis(oxalato) borate, LiBOB). The lithium salt may be used in a concentration ranging from 0.1 M to 2.0 M. When the lithium salt is included at the above concentration range, an electrolyte may have excellent performance and lithium ion mobility due to optimal electrolyte conductivity and viscosity.

The positive electrode includes a positive electrode current collector and a positive active material layer formed on the positive electrode current collector, and the positive active material layer includes a positive active material and carbon nanotube.

An average length of the carbon nanotube may be greater than or equal to 1 μm and less than 200 μm.

For example, the average length of the carbon nanotube may be 50 μm to 150 μm.

When the average length of the carbon nanotube is within the above range, coating uniformity of the positive active material layer may be secured, thereby increasing impregnation properties of the electrode plate in the electrolyte solution to reduce the electrode plate resistance.

The carbon nanotube may be included in an amount of greater than or equal to 0.5 wt % and less than 4 wt % based on the total weight of the positive active material layer.

For example, the carbon nanotube may be included in an amount of 0.5 wt % to 3 wt % based on the total weight of the positive active material layer.

When the content of the carbon nanotube is within the above range, the amount of the dispersant for dispersing the carbon nanotubes may be adjusted to an appropriate amount, and an increase in resistance due to the increase in the amount of the dispersant may be alleviated, thereby preventing deterioration of battery performance.

Meanwhile, the carbon nanotube according to an embodiment of the present invention may be in a form including at least one of a single-walled carbon nanotube, a double-walled carbon nanotube, and a multi-walled carbon nanotube. Among them, single-walled or double-walled carbon nanotubes may improve dispersibility of the slurry containing the carbon nanotubes, and have excellent processability such as coating when forming the active material layer, and at the same time ensure excellent conductivity of the active material layer formed using the same.

The positive active material may include lithiated intercalation compounds that reversibly intercalate and deintercalate lithium ions.

Specifically, a composite oxide of a nickel-containing metal and lithium may be used.

Examples of the positive active material may include a compound represented by any one of the following chemical formulas.

LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5, 0≤c≤0.05); LiₐNi_{1-b-c}CO_{b}X_{c}D_{α} (0.90≤a≤1.8, 0≤b≤0.5, 0≤c≤0.5, 0<α≤2); LiₐNi_{1-b-c}CO_{b}X_{c}O_{2-α}T_{α} (0.90≤a≤1.8, 0≤b≤0.5, 0≤c≤0.05, 0<α<2); LiₐNi_{1-b-c}CO_{b}X_{c}O_{2-α}T_{α} (0.90≤a≤1.8, 0≤b≤0.5, 0≤c≤0.05, 0<α<2); LiₐNi_{1-b-c}Mn_{b}X_{c}D_{α} (0.90≤a≤1.8, 0≤b≤0.5, 0≤c≤0.05, 0<α≤2); LiₐNi_{1-b-c}Mn_{b}X_{c}O_{2-α}T_{α} (0.900≤a≤1.8, 0≤b≤0.5, 0≤c≤0.05, 0<α<2); LiₐNi_{1-b-c}Mn_{b}X_{c}O_{2-α}T_{α} (0.90≤a≤1.8, 0≤b≤0.5, 0≤c≤0.05, 0<α<2); LiₐNi_{b}E_{c}G_{d}O₂ (0.90≤a≤1.8, 0≤b≤0.9, 0<c<0.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃ (0≤f≤2); LiₐFePO₄ (0.90≤a≤1.8)

In chemical formulas, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The compounds may have a coating layer on the surface, or may be mixed with another compound having a coating layer. The coating layer may include at least one coating element compound selected from an oxide of a coating element, a hydroxide of a coating element, an oxyhydroxide of a coating element, an oxycarbonate of a coating element, and a hydroxy carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating process may include any conventional processes as long as it does not cause any side effects on the properties of the positive active material (e.g., spray coating, dipping), which is well known to persons having ordinary skill in this art, so a detailed description thereof is omitted.

The positive active material may be, for example, at least one of lithium composite oxides represented by Chemical Formula 3.

LiₐM¹_{1-y1-z1}M²_{y1}M³_{z1}O₂ [Chemical Formula 3]

In Chemical Formula 3,

0.9≤a≤1.8, 0≤y1≤1, 0≤z1≤1, 0≤y1+z1<1, and M¹, M², and M³ are each independently any one selected from metals such as Ni, Co, Mn, Al, Sr, Mg, or La, and a combination thereof.

In an embodiment, M¹ may be Ni, and M² and M³ may each independently be a metal such as Co, Mn, Al, Sr, Mg, or La.

In a specific embodiment, M¹ may be Ni, M² may be Co, and M³ may be Mn or Al, but are not limited thereto.

In a more specific embodiment, the positive active material may be a lithium composite oxide represented by Chemical Formula 3-1.

Liₓ₂Ni_{y2}CO_{z2}Al_{1-y2-z2}O₂ [Chemical Formula 3-1]

In Chemical Formula 3-1, 1≤x2≤1.2, 0.5≤y2≤1, and 0≤z2≤0.5.

A content of the positive active material may be 90 wt % to 98 wt % based on the total weight of the positive active material layer.

In an embodiment of the present invention, the positive active material layer may include a binder. A content of the binder may be 1 wt % to 5 wt % based on the total weight of the positive active material layer.

The binder improves binding properties of positive active material particles with one another and with a current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

Al may be used as the positive electrode current collector, but is not limited thereto.

The negative electrode includes a negative electrode current collector and a negative active material layer including a negative active material formed on the negative electrode current collector.

The negative active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may be a carbon material which is any generally-used carbon-based negative active material in a lithium ion secondary battery and examples thereof may be crystalline carbon, amorphous carbon, or a combination thereof. Examples of the crystalline carbon may be graphite such as amorphous, sheet-shape, flake, spherical shape or fiber-shaped natural graphite or artificial graphite. Examples of the amorphous carbon may be soft carbon or hard carbon, a mesophase pitch carbonized product, calcined coke, and the like.

The lithium metal alloy may be an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping and dedoping lithium may be Si, a Si—C composite, SiOₓ (0<x<2), a Si-Q alloy (wherein Q is an element selected from an alkali metal, an alkaline-earth metal, a Group 13 element, a Group 14 element, a Group 15 element, a Group 16 element, a transition metal, a rare earth element, and a combination thereof and not Si), Sn, SnO₂, Sn—R (wherein R is an element selected from an alkali metal, an alkaline-earth metal, a Group 13 element, a Group 14 element, a Group 15 element, a Group 16 element, a transition metal, a rare earth element, and a combination thereof, and not Sn), and at least one thereof may be mixed with SiO₂. The elements Q and R may be selected from Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

The transition elements oxide may include vanadium oxide, lithium vanadium oxide, or lithium titanium oxide.

The negative active material according to an embodiment may include a Si—C composite including a Si-based active material and a carbon-based active material.

The Si-based active material may have an average particle diameter of 50 nm to 200 nm.

When the average particle diameter of the Si-based active material is within the above range, volume expansion occurring during charging and discharging may be suppressed, and a break in a conductive path due to particle crushing during charging and discharging may be prevented.

The Si-based active material may be included in an amount of 1 wt % to 60 wt %, or for example, 3 wt % to 60 wt %, based on the total weight of the Si—C composite.

The negative active material according to another embodiment may further include crystalline carbon together with the aforementioned Si—C composite.

When the negative active material includes a Si—C composite and crystalline carbon together, the Si—C composite and crystalline carbon may be included in the form of a mixture, and in this case, the Si—C composite and crystalline carbon may be included in a weight ratio of 1:99 to 50:50. More specifically, the Si—C composite and crystalline carbon may be included in a weight ratio of 5:95 to 20:80.

The crystalline carbon may include, for example, graphite, and more specifically, natural graphite, artificial graphite, or a mixture thereof.

An average particle diameter of the crystalline carbon may be 5 μm to 30 μm.

In the present specification, the average particle diameter may be a particle size (D50) at 50% by volume in a cumulative size-distribution curve.

The Si—C composite may further include a shell surrounding the surface of the Si—C composite, and the shell may include amorphous carbon.

The amorphous carbon may include soft carbon, hard carbon, a mesophase pitch carbonized product, calcined coke, or a mixture thereof.

The amorphous carbon may be included in an amount of 1 to 50 parts by weight, for example 5 to 50 parts by weight, or 10 to 50 parts by weight based on 100 parts by weight of the carbon-based active material.

In the negative active material layer, the negative active material may be included in an amount of 95 wt % to 99 wt % based on the total weight of the negative active material layer.

In an embodiment of the present disclosure, the negative active material layer includes a binder, and optionally a conductive material. In the negative active material layer, a content of the binder may be 1 wt % to 5 wt % based on the total weight of the negative active material layer. When the negative active material layer includes a conductive material, the negative active material layer includes 90 wt % to 98 wt % of the negative active material, 1 wt % to 5 wt % of the binder, and 1 wt % to 5 wt % of the conductive material.

The binder improves binding properties of negative active material particles with one another and with a current collector. The binder includes a non-water-soluble binder, a water-soluble binder, or a combination thereof.

The non-water-soluble binder may be selected from polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The water-soluble binder may be a rubber-based binder or a polymer resin binder. The rubber-based binder may be selected from a styrene-butadiene rubber, an acrylated styrene-butadiene rubber (SBR), an acrylonitrile-butadiene rubber, an acrylic rubber, a butyl rubber, a fluorine rubber, and a combination thereof. The polymer resin binder may be selected from polytetrafluoroethylene, ethylenepropylenecopolymer, polyethyleneoxide, polyvinylpyrrolidone, polyepichlorohydrine, polyphosphazene, polyacrylonitrile, polystyrene, an ethylenepropylenediene copolymer, polyvinylpyridine, chlorosulfonated polyethylene, latex, a polyester resin, an acrylic resin, a phenolic resin, an epoxy resin, polyvinyl alcohol, and a combination thereof.

When the water-soluble binder is used as a negative electrode binder, a cellulose-based compound may be further used to provide viscosity. The cellulose-based compound includes one or more of carboxymethyl cellulose, hydroxypropylmethyl cellulose, methyl cellulose, or alkali metal salts thereof. The alkali metals may be Na, K, or Li. Such a thickener may be included in an amount of 0.1 parts by weight to 3 parts by weight based on 100 parts by weight of the negative active material.

The conductive material is included to provide electrode conductivity and any electrically conductive material may be used as a conductive material unless it causes a chemical change. Examples of the conductive material include a carbon-based material such as natural graphite, artificial graphite, carbon black, acetylene black, ketjen black, a carbon fiber, and the like; a metal-based material of a metal powder or a metal fiber including copper, nickel, aluminum silver, and the like; a conductive polymer such as a polyphenylene derivative; or a mixture thereof.

The negative current collector may be selected from a copper foil, a nickel foil, a stainless steel foil, a titanium foil, a nickel foam, a copper foam, a polymer substrate coated with a conductive metal, and a combination thereof.

A separator may exist between the positive electrode and the negative electrode depending on the type of the lithium secondary battery. Such a separator may include polyethylene, polypropylene, polyvinylidene fluoride, or multi-layers thereof such as a polyethylene/polypropylene double-layered separator, a polyethylene/polypropylene/polyethylene triple-layered separator, and a polypropylene/polyethylene/polypropylene triple-layered separator.

Hereinafter, examples of the present invention and comparative examples are described. These examples, however, are not in any sense to be interpreted as limiting the scope of the invention.

### Manufacture of Lithium Secondary Battery Cell

### Example 1

LiNi_{0.88}Co_{0.105}Al_{0.01502} as a positive active material, polyvinylidene fluoride as a binder, and carbon nanotube (an average length: 50 μm) as a conductive material were mixed in a weight ratio of 96:3:1 and then, dispersed in N-methyl pyrrolidone, preparing positive active material slurry.

The positive active material slurry was coated on a 20 μm-thick Al foil and then, dried at 100° C. and pressed, manufacturing a positive electrode.

Negative active material slurry was prepared by using a mixture of graphite and Si—C composite in a weight ratio of 89:11 as a negative active material, mixing the negative active material with a styrene-butadiene rubber binder, and carboxylmethyl cellulose in a weight ratio of 98:1:1, and then, dispersing the mixture in distilled water.

The Si—C composite had a core including artificial graphite and silicon particles and coal pitch coated on the surface of the core, wherein a content of the silicon was about 3 wt % based on an entire weight of the Si—C composite.

The negative active material slurry was coated on a 10 μm-thick Cu and then, dried at 100° C. and pressed, manufacturing a negative electrode.

The prepared positive and negative electrodes and a 25 μm-thick polyethylene separator were assembled to manufacture an electrode assembly, and an electrolyte solution was injected thereinto, manufacturing a lithium secondary battery cell.

A composition of the electrolyte solution is as follows.

(Composition of Electrolyte Solution)

Salt: 1.5 M LiPF₆

Solvent: ethylene carbonate:ethylmethyl carbonate:dimethyl carbonate (EC:EMC:DMC=20:10:70 in a volume ratio)

Additive: 1 wt % of triphenyl phosphate

(Herein, in the composition of electrolyte solution, “wt %” is based on the total amount of an electrolyte (a lithium salt+a non-aqueous organic solvent+an additive))

### Examples 2 to 4

Each lithium secondary battery cell was manufactured in the same manner as in Example 1 except that the content of the carbon nanotube was respectively changed into 0.5 wt %, 2 wt %, and 3 wt % to manufacture a positive electrode.

### Examples 5 to 7

Each lithium secondary battery cell was manufactured in the same manner as in Example 1 except that the content of the additive was respectively changed into 0.1 wt %, 0.5 wt %, and 2 wt % to prepare an electrolyte solution.

### Examples 8 to 11

Each lithium secondary battery cell was manufactured in the same manner as in Example 1 except that the average length of the carbon nanotube was respectively changed into 1 μm, 5 μm, 100 μm, and 150 μm to manufacture a positive electrode.

### Comparative Example 1

A lithium secondary battery cell was manufactured in the same manner as in Example 1 except that the carbon nanotube was replaced with acetylene black to manufacture a positive electrode, and the electrolyte solution was prepared by adding no triphenyl phosphate.

### Comparative Example 2

A lithium secondary battery cell was manufactured in the same manner as in Example 1 except that the carbon nanotube was replaced with acetylene black to manufacture a positive electrode.

### Comparative Example 3

A lithium secondary battery cell was manufactured in the same manner as in Example 1 except that the electrolyte solution was prepared by using no triphenyl phosphate.

### Comparative Example 4

A lithium secondary battery cell was manufactured in the same manner as in Example 1 except that the content of the carbon nanotube was changed into 4 wt % to manufacture a positive electrode.

### Comparative Example 5

A lithium secondary battery cell was manufactured in the same manner as in Example 1 except that the content of the triphenyl phosphate was changed into 3 wt % to prepare an electrolyte solution.

### Comparative Example 6

A lithium secondary battery cell was manufactured in the same manner as in Example 1 except that the average length of the carbon nanotube was changed into 200 μm to manufacture a positive electrode.

### Comparative Example 7

A lithium secondary battery cell was manufactured in the same manner as in Example 1 except that the content of the carbon nanotube was changed into 0.1 wt % to manufacture a positive electrode.

The lithium secondary battery cells according to Examples 1 to 11 and Comparative Examples 1 to 7 had each composition shown in Table 1.

TABLE 1

| | Composition of | | |
|---|---|---|---|
| | positive electrode | | |
| | Type: | | |
| | content of | | |
| | conductive | Length | Composition of |
| | material | of CNT | electrolyte solution |
| | (wt %) | (μm) | (content of TPP) (wt %) |
| Comparative | acetylene | — | — |
| Example 1 | black: 1 | | |
| Comparative | acetylene | — | 1 |
| Example 2 | black: 1 | | |
| Comparative | CNT: 1 | 50 | — |
| Example 3 | | | |
| Comparative | CNT: 4 | 50 | 1 |
| Example 4 | | | |
| Comparative | CNT: 1 | 50 | 3 |
| Example 5 | | | |
| Comparative | CNT: 1 | 200 | 1 |
| Example 6 | | | |
| Comparative | CNT: 0.1 | 50 | 1 |
| Example 7 | | | |
| Example 1 | CNT: 1 | 50 | 1 |
| Example 2 | CNT: 0.5 | 50 | 1 |
| Example 3 | CNT: 2 | 50 | 1 |
| Example 4 | CNT: 3 | 50 | 1 |
| Example 5 | CNT: 1 | 50 | 0.1 |
| Example 6 | CNT: 1 | 50 | 0.5 |
| Example 7 | CNT: 1 | 50 | 2 |
| Example 8 | CNT: 1 | 1 | 1 |
| Example 9 | CNT: 1 | 5 | 1 |
| Example 10 | CNT: 1 | 100 | 1 |
| Example 11 | CNT: 1 | 150 | 1 |

### Evaluation 1: Impregnation Properties Evaluation of Electrolyte Solution

An electrolyte solution was injected into the electrode assemblies according to Example 1 to 7, and 9 to 11 and Comparative Examples 1, 2, and 4 to 7 to impregnate them.

The electrolyte solution was prepared by using a mixed solvent of EC/EMC/DMC (a volume ratio of 20/10/70) to prepare a 1.5 M LiPF₆ solution and adding 0 wt % to 3 wt % of triphenyl phosphate thereto.

An amount of the electrolyte solution impregnated in the electrode assembly per hour was calculated according to Equation 1.

(a weight of an electrolyte solution after impregnating an electrode assembly+a weight of the electrode assembly)−(a weight of the initial electrode assembly) <Equation 1>

The results are shown in Table 2.

Referring to Table 2, a larger amount of an electrolyte solution was impregnated in an electrode assembly including both carbon nanotube and additive according to examples of the present invention than lithium secondary battery cells including an electrode assembly including neither carbon nanotube nor additive (Comparative Example 1), an electrode assembly including no carbon nanotube (Comparative Example 2), the electrode assemblies in which the content of carbon nanotube is not included within the range of the present invention (Comparative Examples 4 and 7), the electrode assembly in which the content of the additive is not included within the range of the present invention (Comparative Example 5), and the electrode assemblies in which the length of the carbon nanotube is not included within the range of in the present invention (Comparative Example 6).

It was confirmed that the lithium secondary battery cells including the electrode assemblies and the electrolytes according to the examples of the present invention have a greater amount of the electrolyte solution impregnated than the lithium secondary battery cells of the comparative examples.

From this, it can be expected that the lithium secondary battery cells of the embodiment have improved impregnation properties of an electrolyte solution and thus has excellent cycle characteristics compared with the lithium secondary battery cells of the comparative examples.

TABLE 2

| | Impregnation amount of |
|---|---|
| | electrolyte solution (g) |
| Comparative Example 1 | 0.0110 |
| Comparative Example 2 | 0.0108 |
| Comparative Example 4 | 0.0110 |
| Comparative Example 5 | 0.0120 |
| Comparative Example 6 | 0.0120 |
| Comparative Example 7 | 0.0110 |
| Example 1 | 0.0148 |
| Example 2 | 0.0138 |
| Example 3 | 0.0150 |
| Example 4 | 0.0148 |
| Example 5 | 0.0151 |
| Example 6 | 0.0150 |
| Example 7 | 0.0148 |
| Example 9 | 0.0132 |
| Example 10 | 0.0150 |
| Example 11 | 0.0153 |

### Evaluation 2: Evaluation of DC-Internal Resistance (DC-IR)

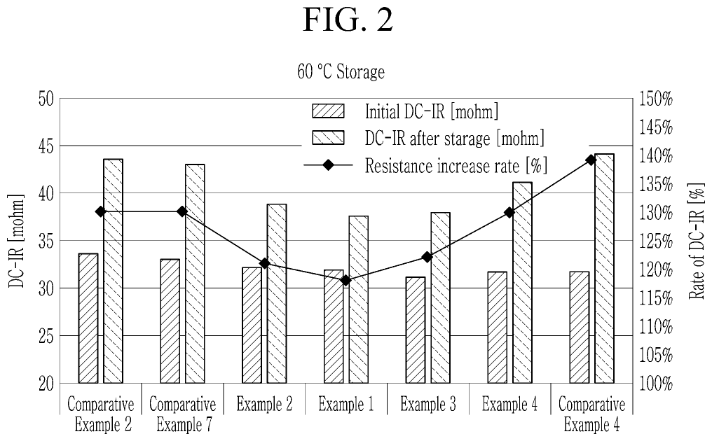

Each lithium secondary battery cell according to Examples 1 to 11 and Comparative Examples 1 to 7 was measured with respect to initial resistance and then, left at 60° C. in a state of charge (SOC=100%) for 30 days and evaluated with respect to an internal resistance increase rate when left at a high temperature (60° C.), and the results are shown in Table 3 and FIGS. 2 to 4.

DC-IR was measured in the following method.

The cells according to Examples 1 to 11 and Comparative Examples 1 to 7 were charged at 4 A (1.6 C) and 4.2 V at room temperature (25° C.) and then, cut off at a current of 75 mA, when a constant voltage of 4.2 V was applied thereto, and paused for 30 minutes. Subsequently, the cells were discharged at 10 A for 10 seconds, at 1 A for 10 seconds, and at 10 A for 4 seconds and then, measured with respect to a current and a voltage at 18 seconds and 23 seconds to calculate initial resistance (a difference between resistance at the 18 seconds and resistance at 23 seconds) according to ΔR=ΔV/ΔI.

The cells were charged under the above buffering charging conditions and left at 60° C. for 30 days and then, measured with respect to DC-IR to calculate a resistance increase rate before and after left according to Equation 2.

Resistance increase rate=(DC-IR after 30 days left/initial DC-IR)×100 <Equation 2>

TABLE 3

| | | DC-IR (mohm) | |
|---|---|---|---|
| | | after high- | |
| | | temperature | Resistance |
| | Initial | storage | increase |
| | DC-IR | (60° C., | rate |
| | (mohm) | 30 days) | (%) |
| Comparative Example 1 | 32.7 | 45.5 | 139 |
| Comparative Example 2 | 33.5 | 43.6 | 130 |
| Comparative Example 3 | 31.5 | 42.5 | 135 |
| Comparative Example 4 | 31.7 | 44.1 | 139 |
| Comparative Example 5 | 35.0 | 48.0 | 137 |
| Comparative Example 6 | 31.0 | 42.5 | 137 |
| Comparative Example 7 | 33.1 | 43.0 | 130 |
| Example 1 | 31.8 | 37.5 | 118 |
| Example 2 | 32.0 | 38.7 | 121 |
| Example 3 | 31.0 | 37.8 | 122 |
| Example 4 | 31.6 | 41.1 | 130 |
| Example 5 | 31.5 | 42.2 | 134 |
| Example 6 | 31.7 | 39.0 | 123 |
| Example 7 | 32.5 | 38.7 | 119 |
| Example 8 | 32.0 | 41.6 | 130 |
| Example 9 | 32.0 | 40.0 | 125 |
| Example 10 | 31.5 | 37.8 | 120 |
| Example 11 | 31.5 | 38.3 | 122 |

FIG. 2 is a graph showing resistance characteristics according to the content of carbon nanotubes for lithium secondary battery cells according to Examples 1 to 4, Comparative Examples 2, and Comparative Examples 4 and 7.

Referring to Table 3 and FIG. 2, the lithium secondary battery cells including greater than or equal to 0.5 wt % and less than 4 wt % of carbon nanotube based on the total weight of the positive active material layer according to Examples 1 to 4 exhibited significantly reduced initial resistance, DC-IR after high-temperature storage, and internal resistance increase rates, compared with the lithium secondary battery cells including no carbon nanotube according to Comparative Example 2, 4 wt % of carbon nanotube according to Comparative Example 4, and less than 0.5 wt % of carbon nanotube according to Comparative Example 7.

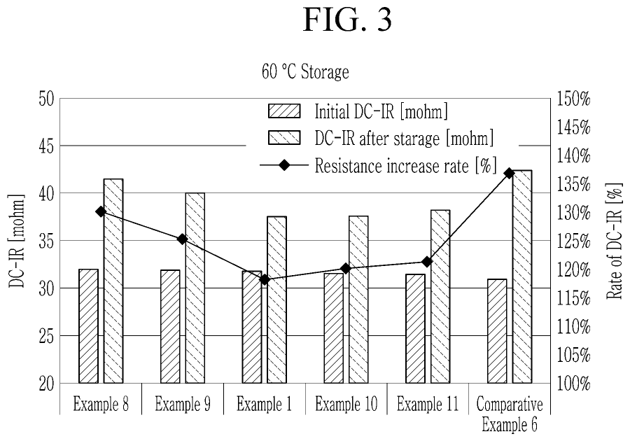

FIG. 3 is a graph showing resistance characteristics of the lithium secondary battery cells according to the length of the carbon nanotube.

Referring to Table 3 and FIG. 3, the lithium secondary battery cells including carbon nanotube with an average length of greater than or equal to 1 μm and less than 200 μm according to Examples 1 and 8 to 11 exhibited significantly reduced initial resistance, DC-IR after high-temperature storage, and internal resistance increase rates, compared with the lithium secondary battery cell including carbon nanotube with an average length of 200 μm according to Comparative Example 6.

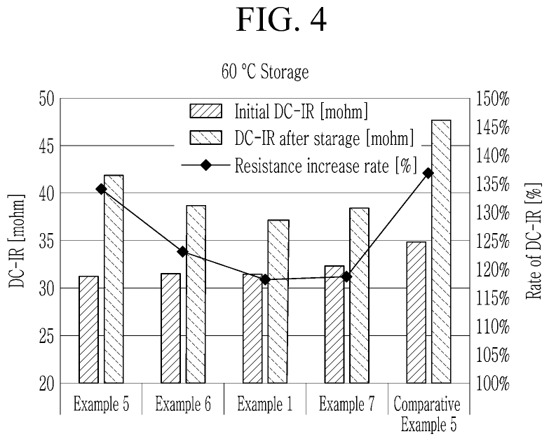

FIG. 4 is a graph showing resistance characteristics of the lithium secondary battery cells according to the content of the additive.

Referring to Table 2 and FIG. 4, the lithium secondary battery cells including the additive in an amount of greater than or equal to 0.1 wt % and less than 3 wt % according to Examples 1 and 5 to 7 exhibited significantly reduced initial resistance, DC-IR after high-temperature storage, and internal resistance increase rates, compared with the lithium secondary battery cell including the additive in an amount of 3 wt % according to Comparative Example 5.

From this, it can be seen that the secondary battery cells according to Examples 1 to 11 have improved high-temperature stability compared with those of Comparative Examples 1 to 7.

Comprehensively, a lithium secondary battery cell according to an example embodiment of the present invention exhibited improved impregnation properties of an electrolyte solution and thus realized excellent cycle characteristics and also, reduced initial resistance and resistance after high-temperature storage and thus improved high-temperature stability.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

1. A lithium secondary battery, comprising
a positive electrode including a positive electrode current collector, and a positive active material layer on the positive electrode current collector;
a negative electrode including a negative active material; and
an electrolyte solution including a non-aqueous organic solvent, a lithium salt, and an additive,
wherein the positive active material layer includes a positive active material and carbon nanotube,
an average length of the carbon nanotube is greater than or equal to 1 μm and less than 200 μm,
the carbon nanotube is included in an amount of greater than or equal to 0.5 wt % and less than 4 wt % based on the total weight of the positive active material layer, and
the additive includes a phosphate-based compound represented by Chemical Formula 1: 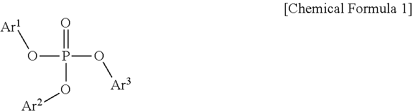
wherein, in Chemical Formula 1,
Ar¹ to Ar³ are each independently a substituted or unsubstituted C6 to C20 aryl group.

2. The lithium secondary battery of claim 1, wherein
an average length of the carbon nanotube is 50 μm to 150 μm.

3. The lithium secondary battery of claim 1, wherein
the carbon nanotube is included in an amount of 0.5 wt % to 3 wt % based on the total weight of the positive active material layer.

4. The lithium secondary battery of claim 1, wherein
the phosphate-based compound represented by Chemical Formula 1 is included in an amount of greater than or equal to 0.1 wt % and less than 3 wt % based on the total weight of the electrolyte solution.

5. The lithium secondary battery of claim 1, wherein
the phosphate-based compound represented by Chemical Formula 1 is triphenyl phosphate (TPP).

6. The lithium secondary battery of claim 1, wherein
the positive active material is at least one type of lithium composite oxide represented by Chemical Formula 2:
LiₐM¹_{1-y1-z1}M²_{y1}M³_{z1}O₂ [Chemical Formula 2]
wherein, in Chemical Formula 2,
0.9≤a≤1.8, 0≤y1≤1, 0≤z1≤1, 0≤y1+z1<1, and M¹, M², and M³ are each independently any one selected from metals of Ni, Co, Mn, Al, Sr, Mg, or La, and a combination thereof.

7. The lithium secondary battery of claim 1, wherein
the positive active material is a lithium composite oxide represented by Chemical Formula 2-1:
Liₓ₂Ni_{y2}CO_{z2}Al_{1-y2-z2}O₂ [Chemical Formula 2-1]
wherein, in Chemical Formula 2-1,
1≤x2≤1.2, 0.5≤y2≤1, and 0≤z2≤0.5.

8. The lithium secondary battery of claim 1, wherein
the negative active material includes a Si—C composite including a Si-based active material and a carbon-based active material.

9. The lithium secondary battery of claim 8, wherein
the negative active material further includes crystalline carbon.

10. The lithium secondary battery of claim 9, wherein
the crystalline carbon includes graphite, and
the graphite includes natural graphite, artificial graphite, or a mixture thereof.

11. The lithium secondary battery of claim 8, wherein
the Si—C composite further includes a shell surrounding the surface of the Si—C composite, and
the shell includes amorphous carbon.

12. The lithium secondary battery of claim 11, wherein
the amorphous carbon includes soft carbon, hard carbon, a mesophase pitch carbonized product, calcined coke, or a mixture thereof.
